(19) United States
(12) Patent Application Publication
(10) Pub. No.: US 2026/0341623 A1
(43) Pub. Date: Oct. 29, 2026

(54) Oxide Photocathode Material And Photocathode Fabrication Method

(71) Applicant: Yecao Technology (Guangzhou) Co., Ltd., Guangzhou (CN)

(72) Inventors: Ruihua He, Hangzhou (CN); Caiyun Hong, Hangzhou (CN); Pengxu Ran, Hangzhou (CN)

(73) Assignee: Yecao Technology (Guangzhou) Co., Ltd., Guangzhou (CN)

(21) Appl. No.: 19/114,564

(22) PCT Filed: Sep. 30, 2022
(86) PCT No.: PCT/CN2022/123415

§ 371 Date: Mar. 24, 2025

(30) Foreign Application Priority Data
Sep. 28, 2022 (CN) 202211194195.9

(51) Int. Cl. H01J 1/34; H01J 9/12

(52) U.S. Cl. CPC H01J 1/34; H01J 9/12

(57) ABSTRACT

The embodiments of the present application provide an oxide photocathode material and a method for fabricating the photocathode. The photocathode material includes an ATiO₃-type material with a perovskite structure, where A is an alkaline earth metal element. The novel photocathode material provided by the embodiments of this application is an alkaline earth-titanium oxide, which features simple fabrication, activation, and reactivation processes, high photoelectric emission brightness, excellent monochromaticity, high collimation, stable performance, and reusability. Moreover, this photocathode material does not contain precious metals or harmful elements, has low production costs, and enables controllable mass production.

### TECHNICAL FIELD

The present application relates to the field of photocathode technology, specifically to an oxide photocathode material and a method for fabricating the photocathode.

### BACKGROUND

When a material is irradiated with light of sufficiently high energy, it generates photoelectrons. The initial photoelectrons produced during illumination transport from the interior of the material to the surface, colliding multiple times with bound electrons in the material, thereby generating secondary photoelectrons. The number of secondary photoelectrons emitted from the material surface is generally much higher than that of the initial photoelectrons. Secondary electron emission materials, which have a higher secondary electron yield (quantum efficiency), are primarily used to fabricate photocathodes.

According to traditional solid-state physics theory, the performance of a photocathode is mainly related to the work function (or photoelectric emission threshold) of the photoelectrons. A smaller work function facilitates easier photoelectric emission. Based on this consideration, photocathodes are typically composed of compounds containing one or more alkali metal elements, also known as alkali photocathodes. Another widely studied and used type is the Negative Electron Affinity (NEA) photocathode, which is based on third-generation III-V semiconductor materials (e.g., GaAs, GaN). However, alkali photocathodes have lower quantum efficiency and spectral response range compared to NEA photocathodes.

Traditional NEA photocathodes face challenges in precisely controlling the amount of Cs deposition and oxygen adsorption during fabrication, increasing the difficulty of producing high-quality NEA photocathodes. Additionally, the surface activation process for NEA photocathodes is complex, and the activated photocathodes require an ultra-high vacuum environment to maintain their performance, with limited lifespan, which restricts their application.

### SUMMARY

To address the shortcomings of existing technologies, the present application proposes an oxide photocathode material and a fabrication method, aiming to solve the technical problems of complex activation processes, poor stability, short lifespan, and high performance requirements in existing photocathodes.

In one aspect, the embodiments of the present application provide an oxide photocathode material, which includes an ATiO₃-type material with a perovskite structure, where A is an alkaline earth metal element.

Optionally, the ATiO₃-type material with a perovskite structure includes one of SrTiO₃, BaTiO₃, and CaTiO₃.

Optionally, the photocathode material further includes doping elements, which include transition metal elements and/or rare earth elements, with the total molar concentration of the doping elements being 0-100% of the molar concentration of Ti in the photocathode material.

Optionally, the ATiO₃-type material with a perovskite structure can exist in one or more forms, including single-crystal, polycrystalline, amorphous, and non-crystalline states.

In another aspect, the embodiments of the present application provide a method for fabricating a photocathode, which includes: Providing a photocathode sample, where the photocathode sample includes a photocathode material layer made of an ATiO₃-type material with a perovskite structure, and A is an alkaline earth metal element. Performing an annealing treatment on the photocathode sample.

Optionally, providing a photocathode sample includes: Providing a substrate and depositing one of SrTiO₃, BaTiO₃, or CaTiO₃ on the substrate to form the photocathode material layer; or Providing a base material that solely includes the photocathode material layer as the photocathode sample.

Optionally, depositing one of SrTiO₃, BaTiO₃, or CaTiO₃ on the substrate to form the photocathode material layer includes: Evaporating one of SrTiO₃, BaTiO₃, or CaTiO₃ onto the substrate while simultaneously doping the photocathode material layer with doping elements, which include transition metal elements and/or rare earth elements, with the total molar concentration of the doping elements being 0-100% of the molar concentration of Ti in the photocathode material layer.

Optionally, performing the annealing treatment on the photocathode sample includes:

Placing the photocathode sample in a vacuum-sealed chamber or in a chamber containing oxygen, hydrogen, or inert gas.

Heating the photocathode sample at a temperature of 500° C.~800° C. for a first duration.

Annealing the heated photocathode sample at a temperature of 600° C.~1600° C. for a second duration.

Optionally, heating the photocathode sample at 500° C.~800° C. for the first duration includes heating it for 1 h~24 h.

Optionally, annealing the heated photocathode sample at 600° C.~1600° C. for the second duration includes annealing it for 0.5 h~12 h.

Optionally, when the photocathode material layer to be formed is in a single-crystal state, providing a substrate includes:

Determining the substrate material based on the photocathode material layer to be formed, where the lattice of the substrate material matches the lattice of the photocathode material layer.

Cleaning the substrate.

Optionally, the thickness of the photocathode material layer is greater than or equal to 0.3 nm.

### Beneficial Technical Effects of the Technical Solutions Provided by the Embodiments of the Present Application

The oxide photocathode material and photocathode fabrication method provided by the embodiments of the present application offer the following beneficial technical effects: Novel Photocathode Material: The new photocathode material is an alkaline earth-titanium oxide, which does not contain alkali metal elements. It eliminates the need for depositing additional materials or adsorbing gases, simplifying the fabrication, activation, and reactivation processes. High Performance: The material exhibits high photoelectric emission brightness, excellent monochromaticity, high collimation, stable performance, and reusability. Cost-Effective and Environmentally Friendly: The photocathode material does not contain precious metals or harmful elements, resulting in low production costs and enabling controllable mass production. Wide Application Potential: Due to its superior photoelectric emission performance, the material is expected to find extensive applications in various fields, including photomultiplier tubes, image intensifiers, ultrafast streak cameras, and detectors for high-energy physics applications. It has unique advantages in particle accelerators, linear colliders, free-electron lasers, ultrafast electron diffraction, spectroscopy, microscopy, and high-power terahertz wave generation.

Additional aspects and advantages of the present application will be partially described below, which will become apparent from the following description or be understood through the practice of the present application.

### BRIEF DESCRIPTION OF THE DRAWINGS

The above and/or additional aspects and advantages of the present application will become apparent and easily understood from the following description of the embodiments with reference to the accompanying drawings, in which:

FIG. 1: Photoelectron energy spectra of the photocathode material provided by the embodiments of the present application at room temperature and low temperature.

FIG. 2: Schematic diagram of the secondary photoelectron distribution of the photocathode material provided by the embodiments of the present application.

FIG. 3: Partial photoelectron energy spectra of the photocathode material provided by the embodiments of the present application before and after exposure to air.

FIG. 4: Comparison of photoelectron energy spectra of two types of photocathode materials provided by the embodiments of the present application at low temperature.

FIG. 5: Schematic diagram of the structure of a photocathode provided by the embodiments of the present application.

FIG. 6: Flowchart of a photocathode fabrication method provided by the embodiments of the present application.

FIG. 7: Flowchart of step S1 in the photocathode fabrication method shown in FIG. 6.

FIG. 8: Flowchart of step S2 in the photocathode fabrication method shown in FIG. 6.

### REFERENCE NUMERALS IN THE DRAWINGS

100: Substrate
200: Photocathode material layer

### DETAILED DESCRIPTION

The embodiments of the present application are described below with reference to the accompanying drawings. It should be understood that the embodiments described herein are exemplary and are intended to explain the technical solutions of the present application, but do not limit the scope of the application.

Those skilled in the art will understand that unless otherwise stated, the singular forms “a,” “an,” “the,” and “said” used herein may also include plural forms. It should be further understood that the term “comprising” used in the description of the present application indicates the presence of the stated features, integers, steps, operations, and/or components, but does not exclude the presence or addition of other features, information, data, steps, operations, components, and/or combinations thereof supported by the technical field. The term “and/or” used herein refers to at least one of the items defined by the term. For example, “A and/or B” can be implemented as “A,” “B,” or “A and B.”

To make the objectives, technical solutions, and advantages of the present application clearer, the following will provide a detailed description of the embodiments of the present application with reference to the accompanying drawings.

When a material is irradiated with light of sufficiently high energy, it generates photoelectrons. The initial photoelectrons produced during illumination transport from the interior of the material to the surface, colliding multiple times with bound electrons in the material, thereby generating secondary photoelectrons. The number of secondary photoelectrons emitted from the material surface is generally much higher than that of the initial photoelectrons. Secondary electron emission materials, which have a higher secondary electron yield (quantum efficiency), are primarily used to fabricate photocathodes.

Photocathodes mainly have two functions: photoelectric signal conversion and electron beam generation. The former is widely used in photomultiplier tubes, image intensifiers, ultrafast streak cameras, and detectors for high-energy physics applications. The latter is a core component of particle accelerators, linear colliders, free-electron lasers, ultrafast electron diffraction, spectroscopy, microscopy, and high-power terahertz wave generation. The photoelectric emission performance of the photocathode used has a critical impact on the overall performance parameters of these devices and systems.

According to traditional solid-state physics theory, the performance of a photocathode is mainly related to the work function (or photoelectric emission threshold) of the photoelectrons. A smaller work function facilitates easier photoelectric emission. Based on this consideration, photocathodes are typically composed of compounds containing one or more alkali metal elements, also known as alkali photocathodes. Cesium antimony (Cs3Sb) photocathodes are the most commonly used alkali photocathode materials with high quantum efficiency (proportional to photoelectric emission brightness under a given incident light intensity). Additionally, bialkali and multialkali antimonides, formed by the reaction of Sb with Na, K, and Cs, achieve a quantum efficiency of up to 30% and exhibit high sensitivity across a broad spectral range from ultraviolet to near-infrared. These materials are used in spectrophotometers and fluorescence measurements in biological and genetic research.

Another widely studied and used type of photocathode is based on third-generation III-V semiconductors (e.g., GaAs, GaN). The surface of semiconductor crystals treated with cesium and oxygen forms a Cs—O monolayer, causing the surface energy band to bend downward. When the bending is sufficient, the surface vacuum level falls below the conduction band minimum inside the material, resulting in a negative effective electron affinity. Photocathode materials realized through this mechanism are called Negative Electron Affinity (NEA) photocathodes, with gallium arsenide (GaAs) NEA photocathodes being the most mature and cost-effective.

However, traditional NEA photocathodes face challenges in precisely controlling the amount of Cs deposition and oxygen adsorption during fabrication, increasing the difficulty of producing high-quality NEA photocathodes. During use, the Cs on the surface is easily affected by external factors and escapes. As the Cs content decreases, the percentage of Cs and O on the cathode surface, as well as the state and structure of the surface layer, change, thereby disrupting the optimal NEA state. Additionally, the surface activation process is complex and cumbersome, with limited repeatability and unstable performance during multiple reactivation cycles. Moreover, due to the high chemical activity of Cs, it readily reacts with environmental impurity gases. Therefore, Cs-activated photocathodes require an ultra-high vacuum environment to maintain their performance and have a limited lifespan, which restricts their application.

Furthermore, compared to NEA photocathode materials, bialkali photocathode materials contain alkali metal elements, which can avoid some of the shortcomings of NEA photocathode materials. However, bialkali photocathode materials have lower quantum efficiency and spectral response range compared to NEA photocathode materials.

The oxide photocathode material and fabrication method provided by the present application aim to address the aforementioned technical problems in existing technologies.

The following describes the technical solutions of the present application and how they solve the above technical problems through specific embodiments. It should be noted that the embodiments described below can be referenced, combined, or integrated with each other. For the same terms, similar features, and similar implementation steps in different embodiments, repeated descriptions are omitted.

The embodiments of the present application provide an oxide photocathode material, which includes an ATiO₃-type material with a perovskite structure, where A is an alkaline earth metal element.

Optionally, the ATiO₃-type material with a perovskite structure includes one of SrTiO₃, BaTiO₃, and CaTiO₃.

Optionally, the photocathode material further includes doping elements, which include transition metal elements and/or rare earth elements, with the total molar concentration of the doping elements being 0-100% of the molar concentration of Ti in the photocathode material. Further, the doping elements specifically include transition metals such as niobium (Nb) or rare earth elements such as lanthanum (La).

Optionally, the ATiO₃-type material with a perovskite structure can exist in one or more forms, including single-crystal, polycrystalline, amorphous, and non-crystalline states.

Specifically, taking Nb doping as an example, the molar concentration of Nb doped into different ATiO₃-type materials with a perovskite structure is 0% (no doping), 0.05%, 0.5%, 1%, 5%, 10%, 25%, 50%, or 100% of the molar concentration of Ti. The crystalline phases of the photocathode material include single-crystal, polycrystalline, amorphous, and non-crystalline states, as well as mixtures of multiple phases. For single-crystal ATiO₃-type materials with a perovskite structure, the surface orientation of the photocathode material is not limited and may include, but is not limited to, (100), (110), and (111). The surface morphology of the photocathode material is also not limited, and it may or may not have atomic-level steps.

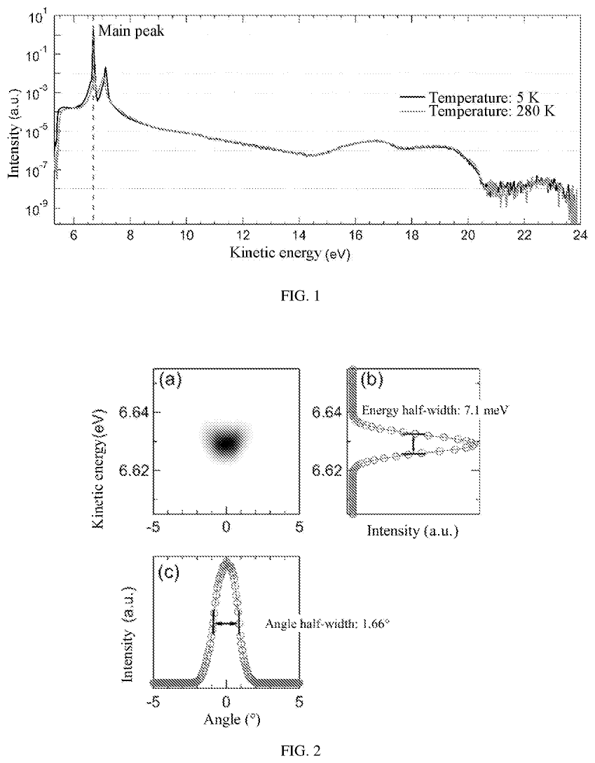

Taking a single-crystal SrTiO₃ (100) substrate with a Nb doping concentration of 0.05% of the molar concentration of Ti (requiring subsequent annealing) as an example, the relevant characteristics of the obtained photocathode material are shown in FIGS. 1 to 3.

Specifically, FIG. 1 shows the photoelectron energy spectra measured using a helium lamp (with a single photon energy of 21.2 eV, corresponding to a wavelength of 58.5 nm) as the incident monochromatic light source, with a 7V acceleration voltage, at near room temperature (280 K) and low temperature (15 K) using an angle-resolved electron spectrometer. The horizontal axis (kinetic energy axis) indicates the photoelectron kinetic energy measured under a 7V (or equivalent) acceleration voltage (applicable to the kinetic energy axes of other figures), and the vertical axis (intensity axis) uses a logarithmic scale.

From FIG. 1, it can be seen that the intensity of the main peak at room temperature is several orders of magnitude higher than the photoelectric emission intensity of the valence band (dashed line position), with the former accounting for more than 98% of the total emitted photoelectrons. The main peak intensity at low temperature shows an additional enhancement of more than two orders of magnitude compared to room temperature. This data demonstrates a high secondary electron emission intensity, proving the high brightness of the material's photoelectric emission.

The relevant data shown in FIG. 2 were obtained under non-monochromatic incident light irradiation for the single-crystal SrTiO₃ (100) substrate with a Nb doping concentration of 0.05% of the molar concentration of Ti. Specifically, FIG. 2(a) shows the distribution of the secondary photoelectron intensity emitted from the photocathode in the kinetic energy-emission angle space, measured using a krypton lamp (with two photon energies of 10.03 eV and 10.65 eV, corresponding to wavelengths of 123.6 nm and 116.4 nm, with an intensity ratio of approximately 4:1) as the incident dual-color light source, with a 7V acceleration voltage, at low temperature (5 K) using an angle-resolved electron spectrometer.

It should be noted that FIG. 2(a) only shows data related to the main peak. FIG. 2(b) and 2(c) show the kinetic energy distribution and emission angle distribution curves of the secondary photoelectrons related to the main peak, respectively. From FIG. 2(b), it can be seen that the secondary electron beam is concentrated in a very narrow energy range (energy half-width of 7.1 meV), indicating that the secondary photoelectrons emitted from the material have high monochromaticity. From FIG. 2(c), it can be seen that the secondary photoelectron emission is mainly concentrated in a small angular range near the surface normal direction (angular full width at half maximum of 1.66°), independent of the incident light direction, indicating that the secondary photoelectron beam emitted from the material has excellent collimation.

In the above embodiments, the incident photon energy is much higher than the photoelectric emission threshold (i.e., the work function, approximately 2.5 eV to 4.5 eV, depending on the material's composition, crystal type, thickness, surface morphology, and annealing temperature and duration). Therefore, this embodiment demonstrates the excellent photoelectric emission performance of the photocathode material under non-threshold incident light excitation, mainly in the following two aspects:
(i) High Monochromaticity of Photoelectron Emission: As shown in FIG. 2, the energy spread of the main peak in the photoelectron energy spectrum of the photocathode material provided by the present application under non-threshold incident light excitation is less than 8 meV, while the minimum energy spread reported for existing photocathode materials under non-threshold incident light excitation is approximately 450 meV (source: Science 316, 1460 (2007)). This shows that under non-threshold incident light conditions, the energy spread of the photoelectric emission of the photocathode material provided by the present application is much smaller than that achievable with existing photocathode technologies, indicating that the new photocathode material has high monochromaticity in photoelectron emission.
(ii) High Collimation of Photoelectron Emission: The divergence angle of the photoelectric emission of the photocathode material provided by the present application under non-threshold incident light excitation is less than 2°, while the divergence angle of photoelectric emission for existing photocathode materials under non-threshold incident light excitation is typically greater than 10°. This shows that under non-threshold incident light irradiation, the angular spread of the photoelectric emission of the photocathode material provided by the present application is smaller than that achievable with existing photocathode technologies, indicating that the new photocathode material has high collimation in photoelectron emission.

It should be noted that the performance of the photocathode material provided by the present application under non-threshold incident light excitation is not only significantly better than that of existing photocathode materials under non-threshold incident light excitation but also comparable to or even better than that of existing materials under threshold incident light excitation.

Furthermore, the relevant data shown in FIG. 2 were obtained under non-monochromatic incident light irradiation. This demonstrates that the high performance of the photocathode material provided by the present application does not depend on the monochromaticity of the incident light, and the photoelectric emission performance is not affected when using non-monochromatic incident light.

Photocathode materials require incident light excitation to generate electron beams, so the excitation light source is an integral part of the photocathode electron source, and its performance directly affects the quality of the emitted electron beam. To meet the requirements for electron beam quality, the new photocathode material provided by the present application can significantly reduce the requirements for the excitation light source in terms of output power, energy tunability, and monochromaticity, thereby greatly reducing the cost of the excitation light source.

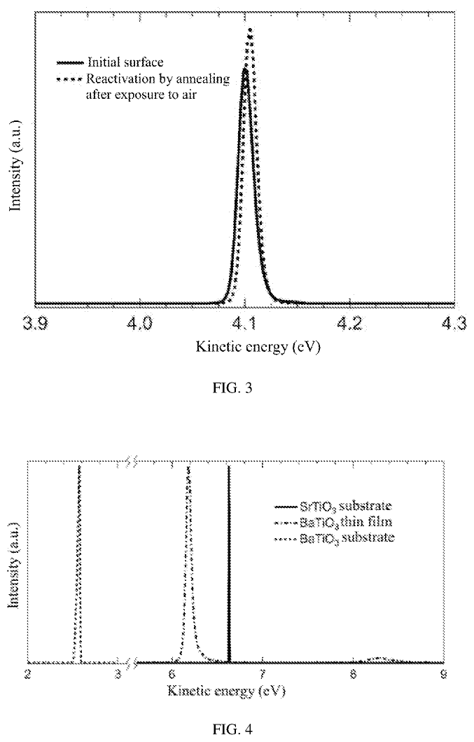

FIG. 3 shows the photoelectron energy spectrum of the photocathode emission in a smaller energy range related to the main peak (using a helium lamp as the incident monochromatic light source and a 7V acceleration voltage). In FIG. 3, the vertical axis (intensity axis) uses a linear scale. Compared to FIG. 1, FIG. 3 shows the results of measurements taken at low temperature (15 K) using the same intensity range of the angle-resolved electron spectrometer after the photocathode sample was exposed to air for two weeks and then subjected to the aforementioned annealing reactivation process to repair its surface reconstruction (i.e., photocathode reactivation). It can be seen that the intensity of the main peak changes little before and after exposure to air, and the material still exhibits excellent photocathode characteristics, indicating that the material's photoelectric emission properties have good air stability.

Taking a single-crystal SrTiO₃ (100) substrate with a Nb doping concentration of 0.05% of the molar concentration of Ti (after subsequent cleaning) as substrate 100, and using BaTiO₃ as the evaporation target material, a BaTiO₃ thin film photocathode material layer 200 (with a (100) single-crystal film) was deposited on substrate 100 using pulsed laser deposition in an evaporation chamber (after subsequent annealing). The relevant characteristics of the obtained BaTiO₃ thin film photocathode material are shown in FIG. 4.

Specifically, FIG. 4 shows the photoelectron energy spectrum measured using a krypton lamp as the incident dual-color light source, with a 7V acceleration voltage, at low temperature (5 K) using an angle-resolved electron spectrometer. For comparison, the photoelectron energy spectrum of the SrTiO₃ (100) sample used in the FIG. 2 experiment was measured under the same experimental conditions. The vertical axis (intensity axis) uses a linear scale.

FIG. 4 also shows the photoelectron energy spectrum of a BaTiO₃ (100) single-crystal substrate (after subsequent annealing) measured using a helium lamp as the incident monochromatic light source, with a 9V acceleration voltage, at low temperature (15 K) using an angle-resolved electron spectrometer.

From FIG. 4, it can be seen that the energy positions and spreads of the main peaks in the photoelectron energy spectra of the two BaTiO₃ (100) samples differ from those of SrTiO₃ (100 ). Specifically, the energy spreads are approximately 65 meV (thin film) and 29 meV (substrate), which are still much smaller than the previously reported minimum energy spread of approximately 450 meV for monochromatic photoelectron energy spectra under non-threshold incident light excitation. This data demonstrates the high secondary electron emission monochromaticity of the two BaTiO₃ (100) photocathodes.

Specifically, the activation and reactivation of the photocathode material can be achieved simply by annealing the material in a vacuum or specific gas atmosphere, without the need to deposit additional materials (such as Cs and O required in conventional photocathode material processes). Therefore, the activation and reactivation methods for the photocathode material provided by this embodiment are simple.

The new photocathode material provided by this embodiment is an alkaline earth-titanium oxide, free of alkali metal elements, and does not require the deposition of any additional materials or adsorption of gases. The fabrication, activation, and reactivation processes are simple, with high photoelectric emission brightness, excellent monochromaticity, high collimation, stable performance, and reusability. Moreover, the photocathode material provided by this embodiment does not contain precious metals or harmful elements, has low production costs, and enables controllable mass production. Particularly, due to its excellent photoelectric emission performance, this photocathode material is expected to find wide applications in various fields such as photomultiplier tubes, image intensifiers, ultrafast streak cameras, and detectors for high-energy physics applications. It has unique advantages in particle accelerators, linear colliders, free-electron lasers, ultrafast electron diffraction, spectroscopy, microscopy, and high-power terahertz wave generation.

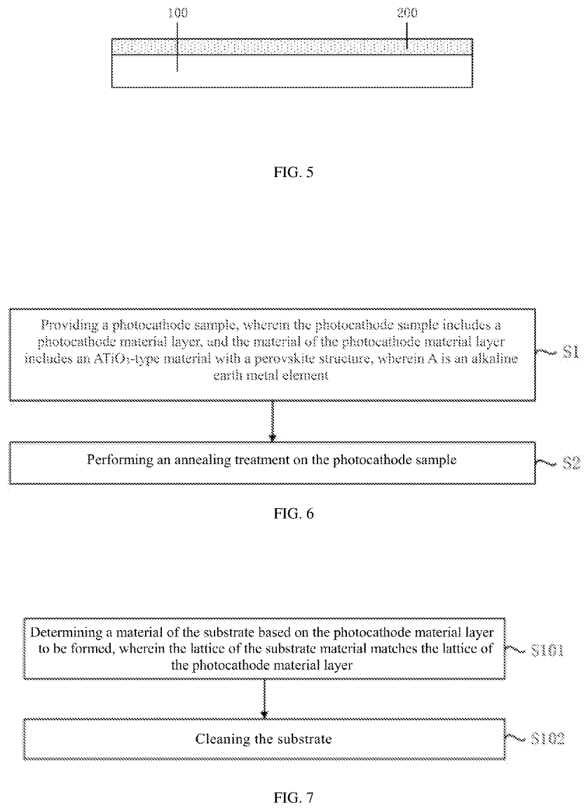

Based on the same inventive concept, the embodiments of the present application also provide a method for fabricating a photocathode. As shown in FIGS. 5 and 6, the photocathode fabrication method provided by this embodiment includes:

S1: Providing a photocathode sample, where the photocathode sample includes a photocathode material layer made of an ATiO₃-type material with a perovskite structure, and A is an alkaline earth metal element.

Specifically, the photocathode sample can have different structures. For example, the photocathode sample may include a substrate 100 and a photocathode material layer 200, or the photocathode sample may be a base material that solely includes the photocathode material layer.

Taking the photocathode sample including substrate 100 and photocathode material layer 200 as an example, step S1 includes: providing a substrate and depositing one of SrTiO₃, BaTiO₃, or CaTiO₃ on the substrate to form the photocathode material layer.

Specifically, this step uses one of SrTiO₃, BaTiO₃, or CaTiO₃ as the evaporation source or target material. For example, a SrTiO₃ target material is evaporated onto substrate 100 using pulsed laser deposition in an evaporation chamber to form photocathode material layer 200.

When it is necessary to prepare a photocathode material layer 200 including doping elements, step S2 specifically includes: using SrTiO₃, BaTiO₃, or CaTiO₃ containing doping elements as the evaporation source or target material to deposit and form photocathode material layer 200 on substrate 100. The doping elements include transition metal elements and/or rare earth elements, with the total molar concentration of the doping elements being 0-100% of the molar concentration of Ti in the photocathode material layer 200. Specifically, this step uses SrTiO₃, BaTiO₃, or CaTiO₃ containing doping elements as the evaporation source or target material. For example, a SrTiO₃ target material doped with Nb is evaporated onto substrate 100 using pulsed laser deposition in an evaporation chamber to form photocathode material layer 200.

In a specific embodiment, taking Nb doping as an example, the molar concentration of Nb doped into different ATiO₃-type materials with a perovskite structure is 0% (no doping), 0.05%, 0.5%, 1%, 5%, 10%, 25%, 50%, or 100% of the molar concentration of Ti. The crystalline phases of the photocathode material include single-crystal, polycrystalline, amorphous, and non-crystalline states, as well as mixtures of multiple phases. For single-crystal ATiO₃-type materials with a perovskite structure, the surface orientation of the photocathode material is not limited and may include, but is not limited to, (100), (110), and (111). The surface morphology of the photocathode material is also not limited, and it may or may not have atomic-level steps. The thickness of the photocathode material layer 200 is greater than or equal to 0.3 nm, with no upper limit. For example, the thickness of the photocathode material layer 200 can be greater than 1 μm.

The substrate 100 serves as a carrier for the subsequent production of the photocathode material layer. Typically, the selection of the substrate 100 is flexible. However, when the photocathode material layer 200 to be formed is in a single-crystal state, the requirements for the substrate 100 are higher. In this case, as shown in FIG. 7, step S1 includes:

S101: Determine the material of the substrate 100 based on the photocathode material layer to be formed. The lattice of the substrate 100 material should match the lattice of the photocathode material layer 200.

S102: Clean the substrate 100. Specifically, chemical cleaning can be used to clean the substrate 100. For example, the substrate 100 can be soaked in alcohol and subjected to ultrasonic oscillation for 10 minutes, followed by rinsing with deionized water for 5 minutes. In practical applications, the soaking medium, soaking time, and rinsing time can be adjusted according to the degree of contamination of the substrate 100.

It should be noted that if the photocathode material layer 200 formed on the substrate 100 is in a non-single-crystal state (polycrystalline, amorphous, or non-crystalline), only cleaning the substrate is required.

S2: Perform an annealing treatment on the photocathode sample.

It should be noted that before performing step S2, if the photocathode sample has been exposed to air, it is necessary to repeat the cleaning process (S102) before starting the annealing process (S2). If the photocathode sample has been kept in a vacuum environment before step S2, the cleaning process can be skipped, and the annealing process can proceed directly.

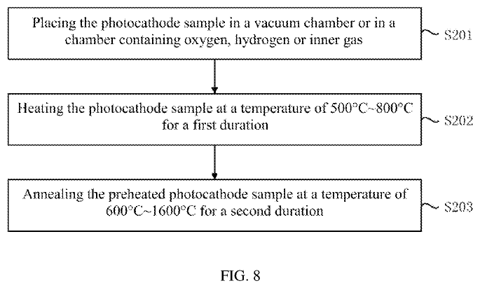

Optionally, as shown in FIG. 8, step S2 in the photocathode fabrication method provided by this embodiment includes:

S201: Place the photocathode sample in a vacuum-sealed chamber or in a chamber containing oxygen, hydrogen, or inert gas. It should be noted that the vacuum-sealed chamber refers to a sealed chamber with a pressure of less than or equal to 10⁻⁷ mbar.

S202: Heat the substrate 100 with the formed photocathode material layer 200 at a temperature of 500° C. to 800° C. for a first duration.

In this step, the photocathode sample is heated at a temperature of 500° C. to 800° C. for a first duration of 1 hour to 24 hours.

Specifically, the photocathode sample is heated at 500° C., 550° C., 600° C., 650° C., 700°°C., 750° C., or 800° C. for a first duration of 24 hours, 12 hours, 8 hours, 4 hours, 2 hours, or 1 hour. The purpose of the heat treatment is to remove gases, moisture, and other impurities adsorbed by the photocathode material layer 200 during the previous steps in the atmospheric environment, causing the impurities to sublimate, vaporize, or desorb.

S203: Perform an annealing treatment on the heated photocathode sample at a temperature of 600° C. to 1600° C. for a second duration.

In this step, the heated photocathode sample is annealed at a temperature of 600° C. to 1600° C. for a second duration of 0.5 hours to 12 hours.

Specifically, the heated photocathode sample is annealed at 600° C., 650° C., 700° C., 750° C., 800° C., 850° C., 900° C., 950° C., 1000° C., 1050° C., 1100° C., 1150° C., 1200° C., 1250° C., 1300° C., 1350° C., 1400° C., 1450° C., 1500° C., 1550° C., or 1600° C. for a second duration of 12 hours, 8 hours, 4 hours, 2 hours, 1 hour, or 0.5 hours. The purpose of the annealing is to improve and eliminate structural defects and stresses left by the previous heat treatment process, while forming or repairing the surface reconstruction or structural type required for photoelectric emission. It should be noted that the optimal annealing temperature for achieving the best photoelectric emission performance varies depending on the specific properties of the sample.

It should be noted that the annealing treatment can form or repair the surface reconstruction or structural type required for photoelectric emission. In other words, the annealing treatment can serve as the activation and reactivation method for the photocathode material provided by the present application, and this activation and reactivation method is simple.

The photocathode fabrication method provided by this embodiment uses a new photocathode material that is an alkaline earth-titanium oxide, free of alkali metal elements, and does not require the deposition of any additional materials or adsorption of gases. The fabrication, activation, and reactivation processes are simple, with high photoelectric emission brightness, excellent monochromaticity, high collimation, stable performance, and reusability. Moreover, the photocathode fabrication method provided by this embodiment does not require the use of precious metals or harmful elements, has low production costs, and enables controllable mass production. Particularly, due to its excellent photoelectric emission performance, this photocathode material is expected to find wide applications in various fields such as photomultiplier tubes, image intensifiers, ultrafast streak cameras, and detectors for high-energy physics applications. It has unique advantages in particle accelerators, linear colliders, free-electron lasers, ultrafast electron diffraction, spectroscopy, microscopy, and high-power terahertz wave generation.

By applying the embodiments of the present application, at least the following beneficial effects can be achieved:

The photocathode material and fabrication method provided by the embodiments of the present application use an alkaline earth-titanium oxide as the photocathode material, which is free of alkali metal elements and does not require the deposition of any additional materials or adsorption of gases. The fabrication, activation, and reactivation processes are simple, with high photoelectric emission brightness, excellent monochromaticity, high collimation, stable performance, and reusability. Moreover, the photocathode material provided by this embodiment does not contain precious metals or harmful elements, has low production costs, and enables controllable mass production. Particularly, due to its excellent photoelectric emission performance, this photocathode material is expected to find wide applications in various fields such as photomultiplier tubes, image intensifiers, ultrafast streak cameras, and detectors for high-energy physics applications. It has unique advantages in particle accelerators, linear colliders, free-electron lasers, ultrafast electron diffraction, spectroscopy, microscopy, and high-power terahertz wave generation.

Those skilled in the art will understand that the various operations, methods, steps, measures, and solutions discussed in the present application can be alternated, modified, combined, or deleted. Furthermore, other steps, measures, and solutions discussed in the present application can also be alternated, modified, rearranged, decomposed, combined, or deleted. Additionally, steps, measures, and solutions from existing technologies that are similar to those disclosed in the present application can also be alternated, modified, rearranged, decomposed, combined, or deleted.

The terms “first” and “second” are used for descriptive purposes only and should not be construed as indicating or implying relative importance or implicitly indicating the number of technical features. Thus, features defined by “first” or “second” may explicitly or implicitly include one or more of the features. In the description of the present application, unless otherwise specified, “a plurality of” means two or more.

It should be understood that although the steps in the flowcharts of the accompanying drawings are shown in a specific order indicated by arrows, the order of implementation of these steps is not limited to the order indicated by the arrows. Unless explicitly stated in this document, in some implementation scenarios of the embodiments of the present application, the steps in each flowchart can be executed in other orders as needed. Moreover, some or all of the steps in the flowcharts may include multiple sub-steps or stages based on actual implementation scenarios. Some or all of these sub-steps or stages can be executed simultaneously or at different times. In different scenarios, the execution order of these sub-steps or stages can be flexibly configured as needed, and the embodiments of the present application do not limit this.

The above description is only part of the implementation of the present application. It should be noted that for those skilled in the art, without departing from the technical concept of the solution of the present application, other similar implementation methods based on the technical ideas of the present application also fall within the protection scope of the embodiments of the present application.

1. An oxide photocathode material, characterized by comprising an ATiO₃-type material with a perovskite structure, wherein A is an alkaline earth metal element.

2. The photocathode material according to claim 1, characterized in that the ATiO₃-type material with a perovskite structure includes one of SrTiO₃, BaTiO₃, and CaTiO₃.

3. The photocathode material according to claim 2, characterized by further comprising doping elements, wherein the doping elements includes transition metal elements and/or rare earth elements, and the total molar concentration of the doping elements is 0-100% of the molar concentration of Ti element in the photocathode material.

4. The photocathode material according to claim 1, characterized in that the ATiO₃-type material with a perovskite structure includes one or more of single-crystal, polycrystalline, amorphous, and non-crystalline forms.

5. A method for fabricating a photocathode, characterized by comprising:
providing a photocathode sample, wherein the photocathode sample includes a photocathode material layer, and the material of the photocathode material layer includes an ATiO₃-type material with a perovskite structure, wherein A is an alkaline earth metal element;
performing an annealing treatment on the photocathode sample.

6. The method for fabricating a photocathode according to claim 5, characterized in that providing a photocathode sample includes:
providing a substrate, depositing one of SrTiO₃, BaTiO₃, and CaTiO₃ on the substrate to form the photocathode material layer;
or, providing a base material that solely includes the photocathode material layer as the photocathode sample.

7. The method for fabricating a photocathode according to claim 6, characterized in that depositing one of SrTiO₃, BaTiO₃, and CaTiO₃ on the substrate by evaporation to form the photocathode material layer includes:
while depositing one of SrTiO₃, BaTiO₃, and CaTiO₃ on the substrate by evaporation to form the photocathode material layer, doping the photocathode material layer with doping elements, wherein the doping elements include transition metal elements and/or rare earth elements, and the total molar concentration of the doping elements is 0-100% of the molar concentration of Ti element in the photocathode material layer.

8. The method for fabricating a photocathode according to claim 5, characterized in that performing the annealing treatment on the photocathode sample includes:
placing the photocathode sample in a vacuum-sealed chamber or in a chamber containing oxygen, hydrogen, or inert gas;
heating the photocathode sample at a temperature of 500° C.~800° C. for a first duration;
annealing the heated photocathode sample at a temperature of 600° C.~1600° C. for a second duration.

9. The method for fabricating a photocathode according to claim 8, characterized in that heating the photocathode sample at a temperature of 500° C.~800° C. for the first duration includes:
heating the photocathode sample at a temperature of 500° C.~800° C. for 1 h~24 h as the first duration.

10. The method for fabricating a photocathode according to claim 8, characterized in that annealing the heated photocathode sample at a temperature of 600° C.~1600° C. for the second duration includes:
annealing the heated photocathode sample at a temperature of 600° C.~1600° C. for 0.5 h~12 h as the second duration.

11. The method for fabricating a photocathode according to claim 6, characterized in that when the photocathode material layer to be formed is in a single-crystal state, providing a substrate includes:
determining the material of the substrate based on the photocathode material layer to be formed, wherein the lattice of the substrate material matches the lattice of the photocathode material layer;
cleaning the substrate.

12. The method for fabricating a photocathode according to claim 6, characterized in that the thickness of the photocathode material layer is greater than or equal to 0.3 nm.
